(19) United States
(12) Patent Application Publication
(10) Pub. No.: US 2026/0258285 A1
(43) Pub. Date: Sep. 3, 2026

(54) WALL COVERING PREPASTED WITH A WATER-ACTIVABLE LATENT ADHESIVE COMPOSITION

(71) Applicant: SAINT-GOBAIN ADFORS, COURBEVOIE (FR)

(72) Inventors: Francisco Javier CEDANO SERRANO, AUBERVILLIERS (FR); Louis GARNIER, COURBEVOIE (FR)

(21) Appl. No.: 18/863,264

(22) PCT Filed: May 10, 2023
(86) PCT No.: PCT/EP2023/062358

§ 371 Date: Nov. 5, 2024

(30) Foreign Application Priority Data
May 12, 2022 (FR) FR2204494

(51) Int. Cl. C09J 7/32; C09J 11/04; E04F 13/00

(52) U.S. Cl. CPC C09J 7/32; C09J 11/04; E04F 13/002; C09J 2203/346; C09J 2301/306; C09J 2301/408; C09J 2400/263

(57) ABSTRACT

A wall covering includes a support with a rear face, prepasted with a layer of water-activable adhesive composition, and a non-prepasted front face, wherein the water-activable adhesive composition includes a cationic electrolyte, an anionic polyelectrolyte and a salt having a solubility in water (at 20° C.) of at least 0.5 mol/L.

The present invention relates to a wall covering prepasted with a water-activable adhesive composition comprising the combination of a cationic polyelectrolyte, an anionic polyelectrolyte and a salt.

The Applicant currently offers a range of fiberglass-based wall coverings, one side of which is coated with a water-activable adhesive, that is, an adhesive that is not tacky in the dry state but whose adhesive character is activable when brought into contact with a sufficient quantity of water.

Such water-activable adhesives are usually based on starches or starch derivatives and their activation requires large quantities of water (around 300 to 400 g/m²). Good control of the amount of water applied is not an easy task and generally requires the use of dedicated damping units and/or the intervention of professional operators. If not enough water is applied or if the application is uneven, the wall covering will not adhere well to the support. If, on the other hand, the latent adhesive is brought into contact with excess water, there is a risk of soiling the workplace through run-off of the wet adhesive composition.

The Applicant thus offers a portable machine dedicated to moistening these starch-based prepasted wall coverings (EasyGlue® technology). This portable machine comprises a channel wherein a holding roller is attached. When the operator wishes to use the machine, said operator fills the channel with water so as to at least partially submerge the holding roller. The operator passes the wall covering strip underneath the holding roller so that the wall covering strip is submerged in water for a few seconds as said operator pulls on the end of the strip.

An improved machine for moistening the water-activable adhesive layer of wall coverings is disclosed in French application No. 2107242, not yet published at the time of filing of the present application.

Due to the difficulty in controlling the amount of water needed to activate the prepasted latent adhesive, there is currently a need for prepasted adhesives that require less water and/or whose activation is easy enough to implement so as not to require a dedicated device and/or the intervention of a professional.

The present invention is based on the discovery that adhesives based on polyelectrolytes with opposite charge polarities, known for many years in the medical and biomedical field as polyelectrolyte complexes/coacervates (PEC) (WO2011/149907A1, WO2011/106595, WO2012/065148, WO2016/011028, WO2019/172764), can be used for prepasting wall coverings and are particularly interesting in that their activation requires significantly less water than starch-based adhesives.

Furthermore, the Applicant has found that the moistened wall covering, once applied to the wall, can be moved more easily and for a longer time than a wall covering pasted with a starch-based adhesive which is generally impossible to slide on the wall around 20 to 30 minutes after application.

A final advantage of the polyelectrolyte and salt-based adhesives of the present invention is that they are very easy to remove. Indeed, simply by spraying salt water onto the bonded covering: the salt solution very quickly diffuses through the thickness of the wall covering and into the entire adhesive layer and the presence of salt ions reduces the electrostatic interaction between polycations and polyanions helping the polyelectrolytes to dissolve, making the wall covering easier to remove.

The present application therefore relates to a wall covering comprising a support with a rear face prepasted with a layer of water-activable adhesive composition and a non-prepasted front face, which wall covering is characterized in that the water-activable adhesive composition comprises a cationic polyelectrolyte, an anionic polyelectrolyte and a salt having a solubility in water (at 20° C.) of at least 0.5 mol/L.

The adhesive composition therefore contains three essential ingredients, namely an anionic polyelectrolyte, a cationic polyelectrolyte and a water-soluble salt. Although the terms “polyelectrolyte” and “salt” are hereafter used in the singular, they also include, unless otherwise specified, mixtures of several anionic or cationic polyelectrolytes and mixtures of several salts.

This adhesive composition is not a PSA (pressure sensitive adhesive) type adhesive, that is, in the dry state it has no sticky or tacky character. The wall covering may therefore be rolled up and marketed in roll form like any other wall covering, whether prepasted or not.

The activation of the adhesive layer is made merely by bringing it into contact with water. The water rapidly diffuses into the adhesive layer, forming a polymer gel swollen by an aqueous salt solution. The polymer gel is formed by combining a cationic polyelectrolyte and an anionic polyelectrolyte. The interaction between the cationic polyelectrolyte and the anionic polyelectrolyte is mainly ionic. The main role of the salt is to attenuate the ionic interaction between the opposite charges of the two types of polyelectrolyte. The greater the ionic strength of the aqueous medium, the less the interaction between the opposite charges and the less viscous the activated (hydrated) adhesive layer.

Polyelectrolytes may be either strong or weak polyelectrolytes. A strong polyelectrolyte is a polymer whose charge is substantially independent of the pH of the medium. Examples of strong polyelectrolytes include polymers comprising a plurality of quaternary amine groups (strong polycations) or polymers comprising a plurality of sulfonate (—SO₃⁻) groups (strong polyanions). Poly (acrylic acid) and polyamines, on the other hand, are examples of weak polyelectrolytes, that is, polymers whose charge is pH-dependent.

In the present application, an anionic polyelectrolyte is a polymer whose net charge at pH 7 is negative and a cationic polyelectrolyte is a polymer whose net charge at pH 7 is positive. This does not mean that an anionic polyelectrolyte comprises only anionic groups and is devoid of cationic charges. By analogy, a cationic polyelectrolyte may comprise both cationic and anionic charges, as long as the cationic charges predominate at pH 7. The definition of anionic polyelectrolytes therefore includes zwitterionic polyelectrolytes having an isoelectric point (pl) below 7, preferably below 6, and the definition of cationic polyelectrolytes includes zwitterionic polyelectrolytes having an isoelectric point (pl) above 7, preferably above 8. The best-known zwitterionic polyelectrolytes are proteins which comprise both acid (—COOH) and amine (—NH₂) side groups.

In a preferred embodiment of the adhesive composition of the present invention, the anionic polyelectrolyte comprises only anionic groups and is free of cationic charges and the cationic polyelectrolyte comprises only cationic groups and is free of anionic charges.

Furthermore, the anionic polyelectrolyte and/or the cationic polyelectrolyte are preferably linear polymers, deprived of branches.

The cationic groups of the cationic polyelectrolyte are for example primary amino, secondary amino, tertiary amino or quaternary ammonium groups, present in the main chain or on side groups.

The anionic groups of the anionic polyelectrolyte are for example carboxylate, sulfonate, phosphonate, boronate, sulfate, borate or phosphate groups, present in the main chain or on side groups of the polymers.

Examples of cationic polyelectrolytes include one or more selected from the group consisting of
poly(diallyldimethylammonium chloride),
poly[(2-hydroxypropyl)dimethylammonium chloride],
polyamidoamine-epichlorohydrin (PAAE),
polyethyleneimine,
poly(acrylamide-co-diallyldimethylammonium chloride),
copolymer of hydroxyethylcellulose and poly(diallyldimethylammonium chloride) (Polyquaternium-4),
copolymer of acrylamide and dimethylaminoethyl methacrylate quaternized with dimethyl sulfate (Polyquaternium-5, CAS 26006-22-4),
copolymer of dimethylaminomethyl methacrylate and alkyl methacrylate,
chitosan,
poly(quaternized N,N-(dimethylamino)ethyl methacrylate),
guar hydroxypropyltrimonium chloride,
poly(N,N-dimethyl-3,5-dimethylene piperidinium chloride),
poly(vinylbenzyltrimethylammonium chloride),
poly[3-(methacryloylamino) propyl-trimethylammonium chloride],
poly(2-(methacryloloxy)ethyl]-trimethylammonium chloride),
polyvinylamine (PVA),
poly(N,N-dimethyl-3,5-dimethylene piperidinium chloride) (PDDPC),
poly(vinylbenzyltrimethylammonium chloride) (PVBTAC),
poly(allylamine hydrochloride) (PAH), and
poly[3-(methacryloylamino) propyltrimethylammonium chloride] (PMAPTAC).

The anionic polyelectrolyte is preferably selected from the group consisting of poly(acrylic acid), poly(sodium 4-styrenesulfonate), lignosulfonate, sodium humate, alginate, poly(sodium 2-acrylamido-2-methyl-1-propanesulfonate), hyaluronic acid, dextran sulfate and poly(sodium vinylsulfonate).

The cationic polyelectrolyte and the anionic polyelectrolyte are used in respective quantities such that the ratio of the number of positive charges present on the cationic polyelectrolyte to the number of negative charges on the anionic polyelectrolyte is comprised between 0.5 and 2, preferably between 0.6 and 1.8, in particular between 0.7 and 1.6, more preferentially between 0.8 and 1.4, and ideally between 0.9 and 1.2.

The weight-average mass (determined by light scattering) of the anionic and cationic polyelectrolytes is advantageously comprised between 1,000 and 1,000,000 Da, for example between 50,000 and 700,000 Da, preferably between 100,000 and 400,000 Da. When their mass is significantly less than about 50,000 Da (in particular less than 1,000 Da), it can be difficult to obtain a dry, tack-free adhesive layer, the wall covering cannot then be marketed in roll form and the adhesion of the wall covering to the wall is generally insufficient. When the weight-average mass of the polyelectrolytes is too high, that is, significantly greater than around 700,000 Da (in particular greater than 1,000,000 Da), the ionic strength and the amount of water required to form a gel of satisfactory consistency are too high.

The Applicant also found that it was important to ensure that the anionic polyelectrolyte and the cationic polyelectrolyte had similar molecular weights. The ratio of the weight-average mass of the anionic polyelectrolyte to the weight-average mass of the cationic polyelectrolyte is comprised between 0.4 and 1.6, preferably between 0.7 and 1.3, particularly between 0.8 and 1.2.

When the weight-average mass of a polyelectrolyte is not provided by the supplier or cannot be determined by light scattering, the Brookfield viscosity of a saline solution of each polyelectrolyte at a given concentration and given pH can be measured. The Brookfield viscosity ratio can then be equated, by approximation, with the ratio of the weight-average masses of the polyelectrolytes.

The water-soluble salt used to mask the opposite charges of polyelectrolytes and to reduce ionic interactions between polyanions and polycations is preferably, but not necessarily, a mineral salt. Preferred mineral salts are selected from the group consisting of alkali metal or alkaline earth metal halides, preferably alkali metal halides. Examples of organic salts include alkali metal or alkaline-earth metal carboxylates or organosulfonates.

Water-soluble salts are preferably monovalent metal salts. When divalent cations (Mg²⁺ or Ca²⁺) are present, they generally represent no more than 20 mol % of the total cations in the salt.

The water-soluble salt content of the dry adhesive layer must be sufficient to create an ionic force in the aqueous medium of the hydrated adhesive layer capable of effectively attenuating the interaction between the opposite polarity charges of the polyelectrolytes. In the absence of salt or in the presence of an insufficient concentration of salt, the polyelectrolytes remain strongly associated with each other. The formation of an aqueous gel, essential for the adhesion of the wall covering to the substrate, would then be impossible.

The appropriate salt content of the adhesive layer depends, inter alia, on the molecular weight of the polyelectrolytes. The higher the average mass of the polyelectrolytes, the greater the amount of salt required.

The salt content is generally comprised between 40% and 95% by weight, preferably between 55% and 75% by weight, and in particular between 60% and 70% by weight, based on the total dry weight of water-soluble salt and anionic and cationic polyelectrolytes.

The water-activable adhesive composition may further contain a total of up to approximately 50%, preferably from 1 to 20% by weight, in particular from 2 to 10%, based on the total weight of polyelectrolytes and salt, of one or more additives selected from the group consisting of mineral or organic fillers, waxes, pigments, colorants, biocidal agents, buffering agents, surfactants, plasticizing agents, tackifiers, thickeners.

The layer of water-activable adhesive composition present on the rear face of the wall covering of the present invention preferably has a thickness comprised between 10 μm and 600 μm, preferably between 30 μm and 300 μm, particularly between 50 μm and 200 μm. This thickness applies to a dry layer (dried in an oven at 80° C. until its weight no longer varies).

The adhesive composition of the present invention can in principle be used to bond any type of flexible, textile- or paper-based wall covering. In other words, the support of the wall covering may be selected, for example, from the group formed by (ordinary) wallpapers, vinyl wallpapers, non-woven wallpapers, Japanese straw, fiberglass wovens, and fiberglass non-wovens or veils. Fiberglass wovens and veils are particularly preferred. The term “woven” encompasses any type of weave, such as twill, satin or leno.

To produce the adhesive composition based on salt and polyelectrolytes, each polyelectrolyte is dissolved separately in a salt solution containing the water-soluble salt. The salt concentration of the solution is advantageously comprised between 0.2 and 2.5 M, preferably between 0.5 and 2 M. The higher the polyelectrolyte mass, the higher the salt concentration. Thus, for weight-average masses less than 100,000 Da, salt concentrations comprised between 0.2 and 1 M are sufficient, whereas for masses above 400,000 Da, salt concentrations greater than 2 M are required.

Once the polyelectrolytes have dissolved completely, the two solutions are simply mixed. A dense liquid phase, called coacervate, is generally formed and sedimented by gravity. The supernatant must be discarded and only the coacervate is used to prepare the adhesive composition. If necessary, phase separation and sedimentation of the coacervate can be accelerated by centrifugation. However, the formation of a dense phase of coacervate and a supernatant phase is not mandatory. Indeed, it is generally possible and preferable to select the proportions of water, salt and polyelectrolytes in such a way that the mixture of anionic polyelectrolyte salt solution and cationic polyelectrolyte salt solution is stable and can be used as is for preparing the adhesive composition.

The content of solid components (polyelectrolytes and salts) in the coacervate or mixture of anionic polyelectrolyte salt solution and cationic polyelectrolyte salt solution is advantageously comprised between 20 and 35% by weight, preferably between 25 and 30% by weight. The polyelectrolytes preferably represent between 4 and 12% by weight, preferably between 5 and 10% by weight, the remainder being formed by the water-soluble salt.

The various additives are added to the polyelectrolyte salt solution mixture or to the coacervate.

The resulting adhesive composition is then applied to the rear face of a wall covering support. The application thickness is advantageously comprised between 100 and 400 μm, particularly between 120 and 300 μm. The adhesive composition layer is then dried at room temperature or with the addition of thermal energy, until it loses its tackiness. The wall covering comprising a layer of water-activable adhesive composition on the rear face can then be rolled up, packaged and marketed.

The activation of the adhesive composition layer is made simply by bringing said layer into contact with a sufficient quantity of water.

The present application thus also relates to a method for applying a wall covering as described above, characterized in that water, preferably tap water, is applied to the water-activable adhesive composition layer so as to obtain an activated adhesive composition layer, and the wall covering is applied so that the activated adhesive composition layer comes into contact with the wall.

Water is advantageously applied to the adhesive composition layer using a sprayer or roller. Since the amount of water required to activate the polyelectrolyte-based adhesive of the present invention is less than that required to activate starch-based adhesives of the prior art, it is not necessary to submerge the wall covering in water.

This is a considerable advantage allowing the wall covering of the invention to be applied by non-professionals without the use of complex machines or tools. The amount of water required to obtain satisfactory activation of the adhesive composition is generally comprised between 80 and 120 g/m², preferably between 85 and 115 g/m², in particular between 90 and 110 g/m².

### EXAMPLES

A cationic polyelectrolyte aqueous salt solution (solution A) and an anionic polyelectrolyte aqueous salt solution (solution B) are prepared separately.

To do this, 107.1 g of KBr potassium bromide is added to 250 ml of water. After dissolving the salt, 312.5 g of an aqueous solution of poly(diallyldimethylammonium chloride) (PDADMAC) with a cationic polyelectrolyte content of 20% (Floset® EVA 462, SNF) is added to the resulting salt solution. The pH of the resulting solution is adjusted to a value of 8 (by adding NaOH or HCl).

Solution A has a PDADMAC content of 15% by weight and a KBr concentration of 1.8 M.

Solution B is prepared by the same procedure, but replacing the aqueous PDADMAC solution with 276.5 g of an aqueous poly(styrene sulfonate) (PSS) solution having a PSS content of 30% by weight (Versa-TL® 130, Nouryon).

Then 1 volume of solution B is poured into 1 volume of solution A, stirring for 5 minutes at around 2000 rpm. The solution is then left to stand for at least a week to allow a dense phase of coacervate to settle at the bottom of the container.

This phase separation step (coacervate/supernatant) can be accelerated by centrifugation at 4000 rpm.

The supernatant is removed and the coacervate phase is applied with a paint roller to a wall covering (pre-painted non-woven on the front face) in order to achieve a wet film thickness of approximately 150 μm. After drying, the adhesive composition layer has a polymer content of approximately 40% by weight and a mineral salt content of approximately 60% by weight.

The adhesive is activated by spraying approximately 100 mL per square meter of tap water.

The ability of the moistened wall covering to slide over a plaster substrate is then evaluated in comparison to a commercial prepasted wall covering (starch-based adhesive) activated with the same amount of water.

The sliding test is carried out as follows: Strips measuring 13 cm×5 cm are cut from the prepasted wall covering according to the invention and from the wall covering prepasted with a starch-based adhesive (Novelio® EasyGlue). The adhesive is moistened (approximately 100 mL/m²) and after one minute, half the surface (6.5 cm×5 cm) is bonded to a plasterboard, with the other half protruding from the plasterboard. After a further 2.5 minutes, a tensile force is applied in the plane of the wall covering using an MTS tensile tester, and the maximum force (Fₘₐₓ, in N) required to cause the wall covering to slide on the plaster substrate is determined. The test is repeated five times for each type of glue. Table 1 shows the mean and standard deviation of the maximum force (Fₘₐₓ) required to trigger sliding.

TABLE 1

| | Fₘₐₓ | Fₘₐₓ (standard |
|---|---|---|
| Wall covering | (mean) | deviation) |
| According to the invention | 94N | 40N |
| Novelio EasyGlue (Comparison) | 207N | 55N |

It can be seen that the wall covering with a polyelectrolyte-based adhesive layer according to the invention is significantly easier to slide over a plaster substrate than the comparative wall covering.

1. A wall covering comprising a support with a rear face, prepasted with a layer of water-activable adhesive composition, and a non-prepasted front face, wherein the water-activable adhesive composition comprises a cationic polyelectrolyte, an anionic polyelectrolyte and a salt having a solubility in water at 20° C. of at least 0.5 mol/L.

2. The wall covering according to claim 1, wherein the cationic polyelectrolyte and the anionic polyelectrolyte are present in respective quantities such that a ratio of a number of positive charges present on the cationic polyelectrolyte to a number of negative charges on the anionic polyelectrolyte is comprised between 0.5 and 2.

3. The wall covering according to claim 1, wherein the salt is selected from the group consisting of alkali or alkaline-earth metal halides.

4. The wall covering according to claim 1, wherein the salt content is comprised between 40% and 95% by weight based on the total dry weight of water-soluble salt and anionic and cationic polyelectrolytes.

5. The wall covering according to claim 1, wherein the anionic polyelectrolyte and/or the cationic polyelectrolyte are linear, unbranched polymers.

6. The wall covering according to claim 1, wherein the anionic and cationic polyelectrolytes each have a weight-average mass comprised between 1,000 and 1,000,000 Da.

7. The wall covering according to claim 1, wherein a ratio of a weight-average mass of the anionic polyelectrolyte to a weight-average mass of the cationic polyelectrolyte is comprised between 0.4 and 1.6.

8. The wall covering according to claim 1, wherein the cationic polyelectrolyte is selected from the group consisting of
poly(diallyldimethylammonium chloride),
poly[(2-hydroxypropyl)dimethylammonium chloride],
polyamidoamine-epichlorohydrin (PAAE),
polyethyleneimine,
poly(acrylamide-co-diallyldimethylammonium chloride),
copolymer of hydroxyethylcellulose and poly(diallyldimethylammonium chloride) (Polyquaternium-4),
copolymer of acrylamide and dimethylaminoethyl methacrylate quaternized with dimethyl sulfate (Polyquaternium-5, CAS 26006-22-4),
copolymer of dimethylaminomethyl methacrylate and alkyl methacrylate,
chitosan,
poly(quaternized N,N-(dimethylamino)ethyl methacrylate),
guar hydroxypropyltrimonium chloride,
poly(N,N-dimethyl-3,5-dimethylene piperidinium chloride),
poly(vinylbenzyltrimethylammonium chloride),
poly[3-(methacryloylamino) propyl-trimethylammonium chloride],
poly(2-(methacryloloxy)ethyl]-trimethylammonium chloride),
polyvinylamine (PVA),
poly(N,N-dimethyl-3,5-dimethylene piperidinium chloride) (PDDPC),
poly(vinylbenzyltrimethylammonium chloride) (PVBTAC),
poly(allylamine hydrochloride) (PAH), and
poly[3-(methacryloylamino) propyltrimethylammonium chloride] (PMAPTAC).

9. The wall covering according to claim 1, wherein the anionic polyelectrolyte is selected from the group consisting of poly(acrylic acid), poly(sodium 4-styrenesulfonate), lignosulfonate, sodium humate, alginate, poly(sodium 2-acrylamido-2-methyl-1-propanesulfonate), hyaluronic acid, dextran sulfate and poly(sodium vinylsulfonate).

10. The wall covering according to claim 1, wherein the layer of water-activable adhesive composition has a thickness comprised between 10 μm and 600 μm.

11. The wall covering according to claim 1, wherein the water-activable adhesive composition further contains a total of up to 50% by weight, based on a total weight of polyelectrolytes and salt, of one or more additives selected from the group consisting of mineral or organic fillers, waxes, pigments, colorants, biocidal agents, buffering agents, surfactants, plasticizing agents, tackifiers, thickeners.

12. The wall covering according to claim 1, wherein the support is selected from the group formed by wallpapers, vinyl wallpapers, non-woven wallpapers, Japanese straw, fiberglass wovens, and fiberglass non-wovens.

13. A method for applying a wall covering according to claim 1, comprising applying water, preferably tap water to the water-activable adhesive composition layer so as to obtain an activated adhesive composition layer, and the wall covering is applied so that the activated adhesive composition layer comes into contact with the wall.

14. The method for applying a wall covering according to claim 13, wherein water is applied to the layer of adhesive composition by means of a sprayer or a roller.

15. The method for applying a wall covering according to claim 13, wherein an amount of water applied is comprised between 80 and 120 g/m².

16. The wall covering according to claim 1, wherein the salt is a mineral salt.

17. The wall covering according to claim 2, wherein the ratio is between 0.6 and 1.8.

18. The wall covering according to claim 3, wherein the alkali or alkaline-earth metal halides are alkali metal halides.

19. The wall covering according to claim 4, wherein the salt content is comprised between 55% and 75% by weight based on the total dry weight of water-soluble salt and anionic and cationic polyelectrolytes.

20. The wall covering according to claim 6, wherein the anionic and cationic polyelectrolytes each have a weight-average mass comprised between 50,000 and 700,000 Da.
